(19) United States
(12) Patent Application Publication
(10) Pub. No.: US 2025/0070867 A1
(43) Pub. Date: Feb. 27, 2025

(54) STORAGE DEVICE AND METHOD FOR CONTROLLING THE STORAGE DEVICE

(71) Applicant: Hitachi, Ltd., Tokyo (JP)

(72) Inventors: Tatsuhiko FUKAZAWA, Tokyo (JP); Yuta Saito, Tokyo (JP); Masateru Hemmi, Tokyo (JP)

(73) Assignee: Hitachi, Ltd., Tokyo (JP)

(21) Appl. No.: 18/601,004

(22) Filed: Mar. 11, 2024

(30) Foreign Application Priority Data
Aug. 23, 2023 (JP) 2023-135450

(51) Int. Cl. H04B 10/03; G06F 3/06; H04B 10/079

(52) U.S. Cl. CPC H04B 10/03; G06F 3/061; G06F 3/0614; G06F 3/0638; G06F 3/0677; H04B 10/0799

(57) ABSTRACT

To efficiently detect a defect and identify a causal portion of the defect while minimizing impact on performance of a storage system. A storage device, including an optical module, receives a data I/O request transmitted from another device via the optical module, and performs I/O processing responding to the data I/O request to a storage unit. The storage device performs, upon receiving a data write request as the data I/O request from another device, transmitting a reception enabled notification being information indicating a state where reception of write data for the data write request is enabled to another device, and starting timing of a write monitoring timer being a timer to monitor a reception state of the write data, and upon timeout of the write monitoring timer, acquiring emitted light quantity of a light emitting element, and outputting information indicating the acquired emitted light quantity.

### BACKGROUND

The present invention relates to a storage device and a method for controlling the storage device.

In recent years, with the expansion of the cloud utilization rate involved in promotion of Digital Transformation (DX), greater reliability and availability have been required of a storage device operating in an Internet Data Center (IDC), etc. Various techniques therefore have been proposed to improve the reliability and availability of such a storage device.

For example, Japanese Unexamined Patent Application Publication No. 2009-110386 describes a storage system including a host device and a storage device connected to the host device via a communication line, which is configured to exchange data continuously with the host device when a failure occurs in an optical module within an interface of the storage device. The storage device has a communication control unit that performs data communication with the host device using a plurality of optical modules. The communication control unit includes a plurality of first optical modules that perform data communication with the host device, a second optical module that performs data communication with the host device in place of the first optical module, and a control unit that when a failure occurs in any of the first optical modules, switches the failed first optical module to the second optical module.

### SUMMARY

A laser element, which is used as a light emitting element in an optical module such as Small Form-Factor Pluggable (SFP), structurally easily induces a defect due to a manufacturing defect, and has a defective mode in which emitted light quantity gradually decreases over time. When light quantity of the light-emitting element decreases, the signal light is not propagated correctly, many transmission errors in a counter device (host device, network equipment, etc.) and many retransmissions from the storage device occur, resulting in degradation in performance of the storage system.

When the defective mode occurs (appears), the light quantity of the light-emitting element gradually decreases. It is therefore necessary to detect occurrence of the defective mode at an early stage before the defective mode has a significant impact on operation of the storage system. In addition, since the degradation in performance of the storage system can be caused by various factors other than the defective mode, such as failures on the counter device side or failures in network equipment, a causal portion must be efficiently identified.

Japanese Unexamined Patent Application Publication No. 2009-110386 describes that when a failure occurs in any of the optical modules, the failed first optical module is switched to a second optical module. However, Japanese Unexamined Patent Application Publication No. 2009-110386 does not disclose a mechanism to detect occurrence of the defective mode at an early stage or a mechanism to efficiently identify a portion causing degradation in performance of the storage system.

An object of the invention, which has been made in view of such background, is to provide a storage device that can efficiently detect a defective mode and identify a causal portion while minimizing impact on performance of a storage system, and a method for controlling the storage device.

One embodiment of the invention to solve the above and other problems is a storage device including an optical module performing optical communication, which receives a data I/O request transmitted from another device via the optical module, and performs I/O processing responding to the data I/O request to a storage unit being communicably connected, the optical module including a light emitting element that generates signal light to be transmitted to the above another device, and a light receiving element that receives the signal light transmitted from the above another device, where the storage device performs, upon receiving a data write request as the data I/O request from the above another device, transmitting a reception enabled notification being information indicating a state where reception of write data for the data write request is enabled, and starting timing of a write monitoring timer being a timer that monitors timeout of the write data, and upon timeout of the write monitoring timer, acquiring emitted light quantity of the light: emitting element, and outputting information indicating the acquired emitted light quantity.

Other problems, configurations, and effects will be clarified by the following description of some embodiments.

According to the invention, it is possible to efficiently detect a defective mode and identify a causal portion while suppressing impact on performance of the storage system.

### BRIEF DESCRIPTION OF THE DRAWINGS

FIG. 1 illustrates an exemplary storage system,

FIG. 2 illustrates an exemplary communication adapter,

FIG. 3 illustrates exemplary communication performed between a host device and a storage device,

FIG. 4 illustrates exemplary light quantity decrease detection processing,

FIG. 5 illustrates exemplary state information,

FIG. 6 illustrates exemplary light quantity decrease detection processing according to a second embodiment,

FIG. 7 illustrates exemplary suspicious portion determination information in the second embodiment,

FIG. 8 illustrates exemplary information output by a management device in the second embodiment,

FIG. 9 illustrates exemplary light quantity decrease detection processing according to a third embodiment,

FIG. 10 illustrates exemplary suspicious portion determination information in the third embodiment, and

FIG. 11 illustrates exemplary information output by a management device in the third embodiment.

### DETAILED DESCRIPTION

Some embodiments of the invention are now described with reference to the drawings. The following embodiments are merely exemplarily given to explain the invention and are each partially omitted or simplified as appropriate to clarify the explanation. The invention can also be implemented in various other forms. Unless otherwise specified, each component may be a single element or may include multiple elements.

In the drawings, the position, size, shape, range, etc. of each component may not represent the actual position, size, shape, range, etc. in order to easily understand the invention. The position, size, shape, range, and the like of the invention, therefore, are not necessarily limited to those in the drawings.

Although various types of information may be exemplarily described using an expression such as “information”, “data”, etc., the various types of information may also be expressed using a data structure other than those, such as “table”. When identification information is described, although expressions such as “identification information,” “identifier,” and “ID” are used, these expressions can be substituted for each other.

In the following, description may be given on processing performed by any of various devices, which functions as an information processing device (computer, calculator), executing a program. The information processing device executes a program with a processor (e.g., Central Processing Unit (CPU), Graphics Processing Unit (GPU)), and performs processing specified by the program while using a storage resource (e.g., memory) and an interface. The processor therefore may be the main body of the processing performed by executing the program. Similarly, a control unit (controller), equipment, a system, a computer, or a node, which includes the processor, may be the main body of the processing performed by executing the program.

The main body of the processing performed by executing the program may be anything that functions at least as an arithmetic unit, and for example, may include a dedicated circuit to perform specific processing, such as Field Programmable Gate Array (FPGA), Application Specific Integrated Circuit (ASIC), Complex Programmable Logic Device (CPLD), and the like.

In the following description, input/output may be expressed as “I/O” (Input/Output), interface as “I/F”

(InterFace), and network as “NW”.

In the following description, the letter “S” prefixed to a reference numeral means a processing step.

### First Embodiment

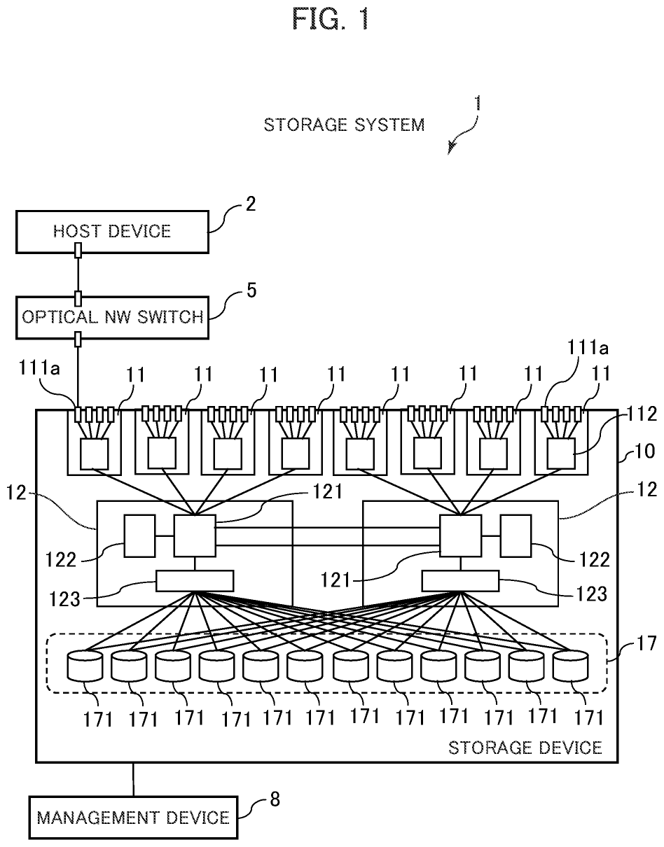

FIG. 1 illustrates a schematic configuration of a storage system 1 according to a first embodiment of the invention. As shown in FIG. 1, the storage system 1 includes a host device 2, an optical network switch 5 (hereinafter referred to as “optical NW switch 5”), a storage device 10, and a management device 8. The host device 2 is also referred to as a “server device,” “external device,” “upper device,” or the like. Of these, the optical NW switch 5 is not necessarily essential as a component of the storage system 1, and the host device 2 and the storage device 10 may be directly connected without the optical NW switch 5.

The optical NW switch 5 is a network device that configures a storage network (hereinafter also referred to as “SAN” (Storage Area Network)), and is, for example, a fibre channel switch (FC-SW: Fibre Channel SWitch). The optical NW switch 5 has one or more communication ports, to any of which an optical cable is connected for connection to the host device 2, and one or more communication ports, to any of which an optical cable is connected for connection to the storage device 10.

The host device 2 is an information processing device (computer), for example, a personal computer, an office computer, or a mainframe. The host device 2 uses a storage area provided by the storage device 10 as a data storage location. When accessing the storage area, the host device 2 transmits an I/O request (data write request (Write Command), data read request (Read Command), etc.) to the storage device 10.

The storage device 10 has one or more communication adapters 11, one or more control units 12, and one or more storage units 17. The communication adapter 11 is also referred to as a “Channel Adapter”, “Channel Board”, or the like. The communication adapter 11 and the control unit 12 are connected via an internal bus (for example, Peripheral Component Interconnect-Express (PCIe)) capable of high-speed communication. The control unit 12 and the storage unit 17 are connected together via a communication system capable of high-speed communication (e.g., high-speed serial communication I/F (Serial ATA (SATA), etc.), Fibre Channel, Serial Attached SCSI (SAS), or Non-Volatile Memory Express (NVMe)).

The communication adapter 11 has one or more communication ports 111a for connection to the optical NW switch 5. The communication adapter 11 receives a data I/O request transmitted from the host device 2, and transfers the received data I/O request and data (for example, write data) transmitted with the data I/O request to the control unit 12. Furthermore, the communication adapter 11 receives data (read data from the storage unit 17, etc.) transmitted from the control unit 12, and transmits the received data to the host device 2. Furthermore, the communication adapter 11 mutually converts the communication protocol on the optical NW switch 5 side and the communication protocol on the control unit 12 side in communication via the SAN between the storage device 10 and a counter device.

The control unit 12 has a processor 121, a cache memory 122, and a drive control unit 123. The processor 121, the cache memory 122, and the drive control unit 123 are communicably connected via a high-speed communication unit such as the internal bus (PCIe, etc.), for example. The illustrated storage device 10 has a redundant configuration including a plurality of control units 12 to ensure availability and for load distribution.

The processor 121 is configured with CPU, a Micro Processing Unit (MPU), a Direct Memory Access (DMA), a timing element (timer, Real Time Clock (RTC), etc.), and the like. The processor 121 performs processing for data transfer between the communication adapter 11, the cache memory 122, and the drive control unit 123 in response to an I/O request transmitted from the communication adapter 11. For example, the processor 121 transfers data (read data from the storage unit 17 and write data to the storage unit 17) between the communication adapter 11 and the drive control unit 123 via the cache memory 122. The processor 121 further performs staging of data to the cache memory 122 (reading data from the storage unit 17 to the cache memory 122) and destaging of data stored in the cache memory 122 (writing data from the cache memory 122 to the storage unit 17).

The processor 121 has the storage unit (Random Access Memory (RAM), Read Only Memory (ROM), Non-Volatile Random Access Memory (NVRAM), etc.) inside, and can store programs and data. The processor 121 executes the above programs stored in the storage unit to effectuate various functions of the control unit 12.

The cache memory 122 is configured with a memory element that can be accessed at high speed, such as dynamic random access memory (DRAM). The cache memory 122 stores, for example, write data to be written to the storage unit 17, read data read from the storage unit 17, and various types of information used to monitor or control the storage device 10.

During reading data from the storage unit 17 to the cache memory 122, or during writing data from the cache memory 122 to the storage unit 17, the drive control unit 123 performs processing for data transfer with the storage unit 17.

The storage unit 17 has one or more storage drives 171, each being a physical recording medium. The storage drive 171 is, for example, a solid-state drive (SSD) or a hard disk drive (HDD). The storage unit 17 may be housed in the same housing (case, rack, etc.) as the storage device 10, or may be housed in a different housing from the housing in which the storage device 10 is housed. For example, the storage unit 17 may provide the above storage area to the control unit 12 as a logical storage area organized using Redundant Array of Inexpensive Disks (RAID) technology or the like.

The management device 8 has a processor, the storage unit (memory (RAM, ROM, NVRAM), SSD, HDD, etc.), in which programs and data are stored, an input device (keyboard, mouse, touch panel, microphone, etc.), an output device (display, light-emitting diode (LED), etc.), and a communication device, and monitors and controls each component of the storage device 10. The management device 8 is communicably connected to the communication adapter 11, the control unit 12, and the storage unit 17 via the communication unit such as Local Area Network (LAN) or the internal bus (PCIe, etc.). The functions of the management device 8 are effectuated when the processor reads and executes the program stored in the storage unit. The management device 8 may include a reading device for a recording medium in which programs and data are stored. The above programs and data can be read from a non-temporary storage medium, such as an optical storage unit (Compact Disc (CD), Digital Versatile Disc (DVD), etc.), the storage system, an IC card, an SD card, and a storage area of a cloud server, to the storage unit of the management device 8 or various storage units provided in the storage device 10 via a recording-medium reading device or a communication device.

The management device 8 monitors and controls components of the storage device 10, for example, via a SerVice Processor (SVP) in the storage device 10. The management device 8 acquires operating information etc. from the communication adapter 11, the control unit 12, and the storage unit 17 at any time, and provides the acquired information to a user via a user I/F. Furthermore, the management device 8 receives information and instructions for settings and control from the user via the user I/F, and sets up and controls the communication adapter 11, the control unit 12, and the storage unit 17 based on the received information and instructions.

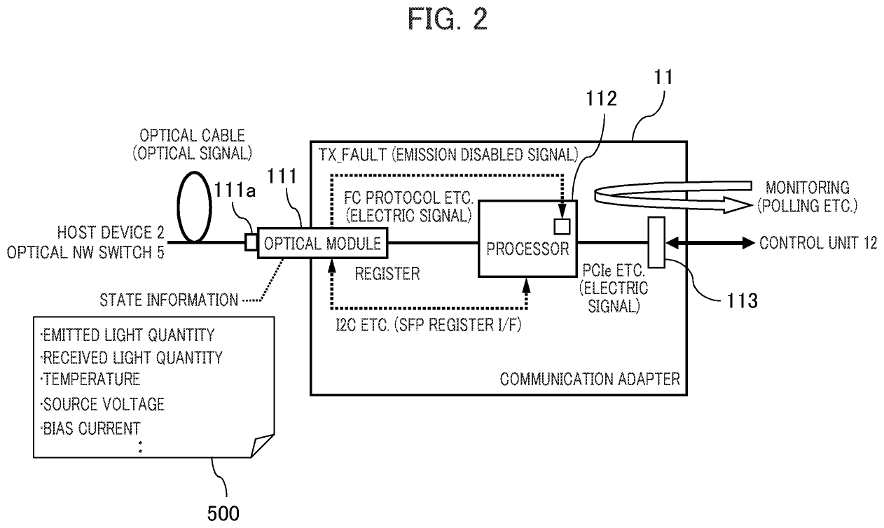

FIG. 2 illustrates a configuration of the communication adapter 11. As illustrated in FIG. 2, the communication adapter 11 includes an optical module 111, a processor 112, and an internal communication I/F 113.

The optical module 111 has one or more communication ports 111a to which an optical fibre is connected, and communicates with the host device 2 via the SAN. Examples of the optical module 111 include a Small Form factor Pluggable (SFP) transceiver and a Quad SFP (QSFP).

The processor 112 is CPU, MPU, or the like. The processor 112 includes a storage element such as, for example, RAM, ROM, or a non-volatile memory (NVRAM), and the timing element (timer, RTC, etc.). The processor 112 performs processing for conversion between the communication protocol on the optical NW switch 5 side and the communication protocol on the control unit 12 side. The processor 112 is also referred to as a “protocol chip.”

The internal communication I/F 113 communicates with the control unit 12 via the internal bus or the like.

Each communication port 111a of the optical module 111 includes a light emitting part that generates (performs electrical/optical conversion) signal light (hereinafter referred to as “transmission signal light”) to be transmitted to the optical NW switch 5, and a light receiving part that generates (performs optical/electrical conversion) signal light (hereinafter, referred to as “received signal light”) transmitted from the optical NW switch 5. The light emitting part is configured with a light emitting element (laser diode, etc.) that converts an electrical signal into the transmission signal light. The light receiving part is configured with, for example, a light receiving element (photodiode, etc.) that converts the received signal light into an electrical signal.

The optical module 111 includes a microcomputer having a processor and a memory, and various sensors. The optical module 111 stores information acquired by the various sensors (hereinafter referred to as “state information”) in the memory. The state information includes, for example, information indicating the following: the emitted light quantity (emission intensity) of the light emitting element of the light emitting part; the received light quantity (received light intensity) of the light receiving element of the light receiving part; temperature measured by a temperature sensor provided inside the optical module 111; bias current of the light emitting element; and source voltage. The optical module 111 inputs an interrupt signal (Tx fault), which notifies that the light emitting element of the light emitting part does not light up, to the processor 112 (latches the interrupt signal in a register). In the following description, the term “state information” includes the information based on the above interrupt signal (information indicating whether the light emitting part is on or off).

The control unit 12 of the storage device 10 can monitor (health-check) the state information stored in the optical module 111 by communicating with the communication adapter 11 (for example, by performing polling). When detecting abnormality or failure in the optical module 111 by the above monitoring, the control unit 12 outputs information based on the state information to the management device 8 as warning information, etc. (provides the information to a user by dumping, messaging, or the like). Further, the control unit 12 closes the communication port of the relevant optical module 111 when determining it necessary.

To prevent deterioration in performance of the storage system 1 due to occurrence of the defective mode in the optical module 111, it is necessary to detect a decrease in light quantity of the light emitting element configuring the light emitting part as early as possible so as to quickly take a necessary measure (replacement of a function by another optical module 111, replacement of the optical module 111, etc.). In such a case, the following matters should be noted.

For example, if the control unit 12 acquires the light quantity of the light emitting element from the optical module 111 (reading the state information by regular polling, etc.) during actual operation of the storage device 10, I/O processing of the storage device 10 may be affected, resulting in deterioration in performance of the storage system 1.

For example, the decrease in light quantity of the light emitting element of the optical module 111 can also be detected based on a communication failure in a counter device (host device 2, optical NW switch 5) connected to the storage device 10. In such a case, however, it is necessary to separately provide a mechanism on the storage device 10 side to check the communication failure or the like that occurs in the counter device.

In addition, even if the communication failure is detected on the counter device side, it is not necessarily easy to isolate the causes of the failure (for example, due to a decrease in light quantity of the light emitting element of the optical module 111 of the storage device 10, or due to a failure in the SAN, etc.).

In consideration of the above, therefore, the storage device 10 of this embodiment has the following mechanism.

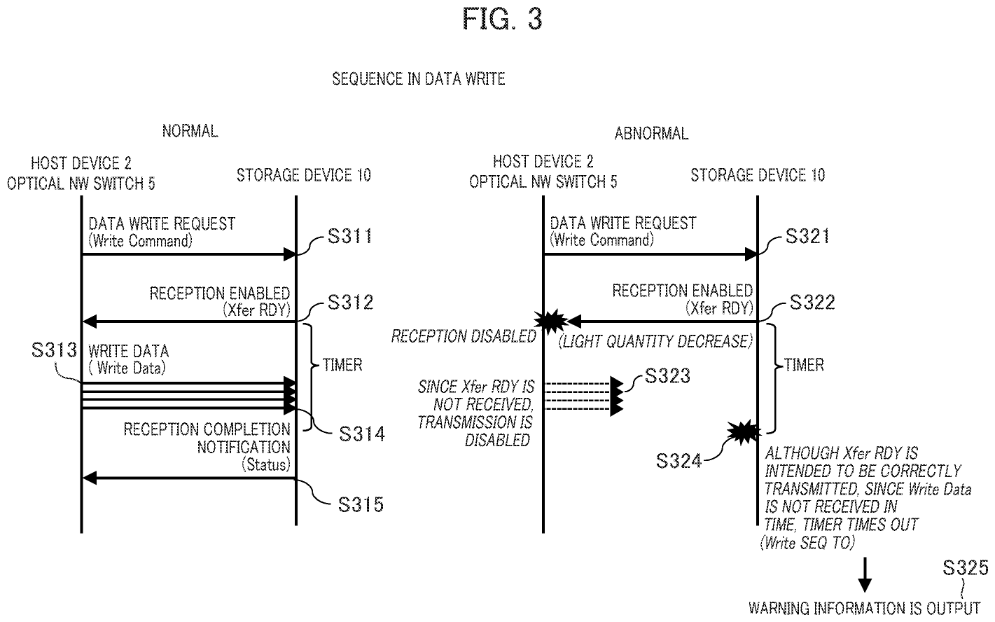

FIG. 3 illustrates the above mechanism, i.e., a sequence of processing performed between the host device 2 and the storage device 10 when a data write request (Write Command) is transmitted from the host device 2 to the storage device 10 via the optical NW switch 5. The sequence diagram shown in the left column of FIG. 3 illustrates the above processing when processing for a data write request is performed normally, and the sequence diagram shown in the right column of FIG. 3 illustrates the above processing when an abnormality such as a communication failure occurs due to a decrease in light quantity of the light emitting element of the light emitting part (such as when a defective mode occurs).

As shown in the sequence diagram in the left column of the figure, if the data write request is processed normally, when the storage device 10 receives a data write request from the host device 2 (S311), it returns a data transmission start enabled notification (Xfer RDY (Ready)) back to the host device 2, and starts counting a timer (hereinafter, referred to as “write monitoring timer”) (S312).

Subsequently, transmission of write data (Write Data) is started from the host device 2 to the storage device 10 (S313). Thereafter, when the transmission of the write data is completed (the storage device 10 completes receipt of write data) without time-out of the write monitoring timer (without exceeding the preset threshold time) (S314), the storage device 10 transmits a write-data reception completion notification (Status) to the host device 2 (S315).

On the other hand, as shown in the sequence diagram in the right column of FIG. 3, if an anomality, such as a communication failure due to a decrease in light quantity of the light emitting element, occurs (such as when the defective mode occurs), when the storage device 10 receives a data write request from the host device 2 (S321), it transmits a write data reception enabled (ready to receive) to the host device 2, and starts counting of the write monitoring timer (S322).

However, since the light quantity of the light emitting element decreases and transmission errors occur frequently due to the occurrence of the defective mode, the host device 2 cannot receive the data transmission start enabled notification (Xfer RDY) from the storage device 10 (S323), and thus the host device 2 cannot start transmission of data to the storage device 10. The storage device 10 therefore cannot receive write data from the host device 2, and if the threshold time is exceeded, the write monitoring timer times out (Write SEQ TO (Sequence Timeout)) (S324). With a trigger of the timeout, the storage device 10 acquires the state information of the optical module 111, and outputs warning information including the acquired information (such as emitted light quantity of the light emitting element) to the management device 8 (provides the information to the user by dumping, etc.) (S325).

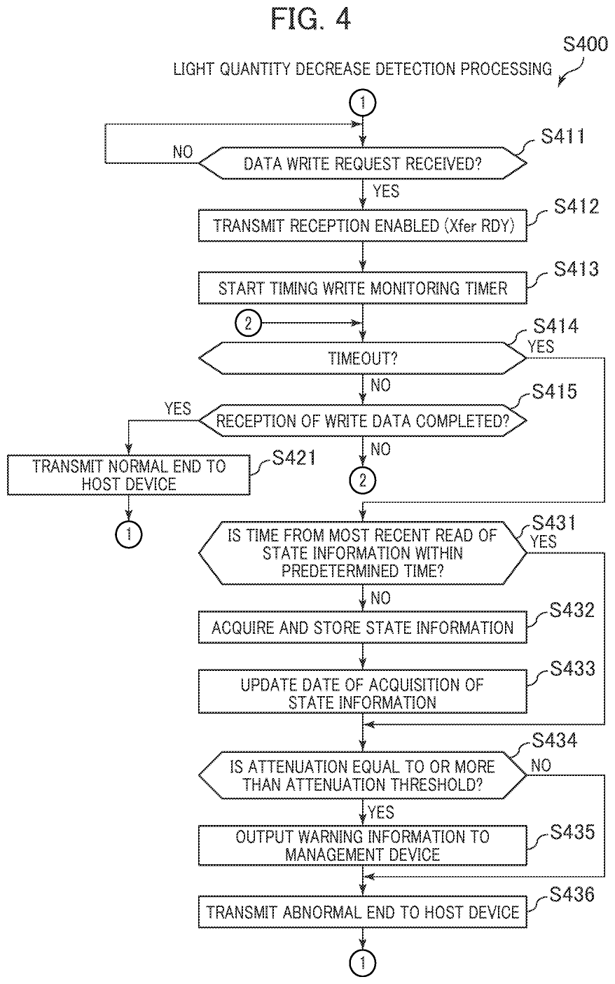

FIG. 4, which illustrates the above mechanism shown with FIG. 3 in more detail, is a flowchart illustrating the processing (hereinafter referred to as “light quantity decrease detection processing S400”) performed by the control unit 12 of the storage device 10 when the storage device 10 receives a data write request (write Command) from the host device 2. The light quantity decrease detection processing S400 is now described with reference to FIG. 4.

The control unit 12 monitors reception of the data write request from the host device 2 in real time (S411: NO). When the control unit 12 receives the data write request from the host device 2 (S411: YES), it transmits a data transmission start enabled notification (Xfer RDY) to the host device 2 and waits for reception of write data (S412), and starts timing (counting) of the write monitoring timer (S413).

Subsequently, the control unit 12 monitors whether the write data is received, and also monitors whether the write monitoring timer has timed out (S414 to S415). If the write data has been received before timeout of the write monitoring timer (S415: YES), the processing proceeds to S421. On the other hand, if the write monitoring timer times out before the write data has been received (S414: YES), the processing proceeds to S431.

In S421, the control unit 12 transmits to the host device 2 that the data write request has been normally ended. After that, the processing returns to S411.

In S431, the control unit 12 determines whether the elapsed time from the time when the state information has been most recently acquired from the communication adapter 11 (communication adapter 11 mounted with the optical module 111 that has received the data write request) to the present time is within a preset predetermined time. If the elapsed time is within the predetermined time (S431: YES), the processing proceeds to S434. On the other hand, if the elapsed time exceeds the predetermined time (S431: NO), the processing proceeds to S432.

In S432, the control unit 12 newly acquires the state information from the optical module 111 of the communication adapter 11, which has received the data write request, and stores the state information. The control unit 12 updates “the date when the state information has been acquired” managed thereby (stored therein) to the date when the state information is newly acquired (S433).

The state information is newly acquired from the communication adapter 11 only when the elapsed time exceeds the predetermined time in S431 to S433, which is to prevent deterioration in performance of the storage device 10 due to frequent accesses from the control unit 12 to the communication adapter 11 and/or the optical module 111.

In S434, the control unit 12 determines whether a difference (hereinafter, referred to as “attenuation”), which is included in the newly acquired state information, between the light quantity of the light emitting element of the light emitting part and the initial value of the light quantity is equal to or larger than a preset threshold (hereinafter, referred to as “attenuation threshold”). If the attenuation is less than the attenuation threshold (S434: NO), the processing proceeds to S436. On the other hand, if the attenuation is equal to or larger than the attenuation threshold (S434: YES), the control unit 12 outputs warning information together with the identification information of that optical module 111 to the management device 8 (S435). After that, the processing proceeds to S436.

In S436, the control unit 12 transmits to the host device 2 that the data write request has ended abnormally. After that, the processing returns to S411.

Since there are individual differences between the light quantity of the light emitting elements of the light emitting part, the storage device 10 needs to acquire the initial light quantity of the individual light emitting element of the optical module 111 (hereinafter referred to as “initial value of emitted light quantity”) used for comparison with the newly acquired emitted light quantity in order to accurately detect the decrease in emitted light quantity of the light emitting element.

As a possible method of acquiring the initial value of the light quantity, for example, the light quantity of the light emitting element is measured at the beginning of use of the optical module 111 (for example, at initialization of the storage device 10 or the communication adapter 11). However, the light emitting element usually starts light emission after the actual operation of the storage device 10 has started, and thus the emitted light quantity of the light emitting element cannot be measured before start of the actual operation.

Therefore, for example, the emitted light quantity of the light emitting element of the optical module 111 is measured at the time of factory shipment or product shipment of the storage device 10 or the optical module 111, and the measured emitted light quantity is stored in a nonvolatile memory (NVRAM) in the optical module 111 as the initial value of the emitted light quantity (for example, stored as state information). In addition, the control unit 12 acquires the initial value of the emitted light quantity from the optical module 111 during an initialization process of the storage device 10 or the communication adapter 11, which is performed before start of actual operation of the storage device 10.

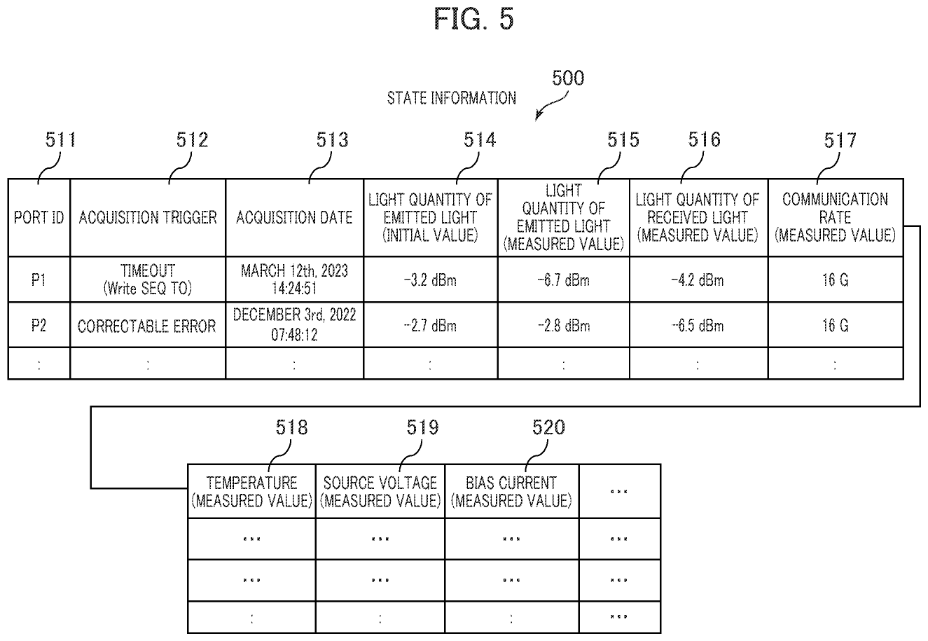

FIG. 5 shows an example of the state information stored in the optical module 111. The illustrated state information 500 includes a record for each of the communication ports including the items of port ID 511, acquisition trigger 512, acquisition date 513, emitted light quantity (initial value) 514, emitted light quantity (measured value) 515, received light quantity (measured value) 516, communication rate (measured value) 517, temperature (measured value)) 518, source voltage (measured value) 519, bias current (measured value) 520, and the like.

Among the above items, the port ID 511 stores port IDs that are identifiers of the communication ports of the optical module 111. The port ID may include identification information of the optical module 111 providing the relevant communication port. The acquisition trigger 512 stores information indicating a trigger (causal event) of acquiring the state information of the relevant communication port. The acquisition date 513 stores the acquisition date of the information of the relevant record.

The emitted light quantity (initial value) 514 stores the initial value of the light quantity of the light emitting part of the relevant communication port of the relevant optical module 111. The emitted light quantity (measured value) 515 stores the emitted light quantity measured by a sensor for the light emitting element of the light emitting part of the relevant communication port.

The received light quantity (measured value) 516 stores the received light quantity measured by a sensor for the light receiving element of the light receiving part of the relevant communication port.

The communication rate (measured value) 517 stores the communication rate at the relevant communication port. In the fibre channel, communication is performed at one of several rates predefined by a standard. The communication rate can be acquired or determined, for example, from information in a register of the processor 112 connected to the optical module 111.

The temperature (measured value) 518 stores internal temperature of the optical module 111 measured by a sensor.

The source voltage (measured value) 519 stores a source voltage of the optical module 111 measured by a sensor.

The bias current (measured value) 520 stores bias current of the light emitting element measured by a sensor.

As described above, the storage device 10 of this embodiment starts timing of the write monitoring timer when it receives a data write request and starts waiting to receive write data from the host device 2. The storage device 10 newly acquires state information (light quantity of the light emitting element, etc.) from the optical module 111 with a trigger of timeout of the write monitoring timer. As a result, impact on performance of the storage device 10 can be suppressed compared to the case where the control unit 12 periodically accesses the optical module to acquire the state information by polling or the like.

The case where the write monitoring timer times out is a case where the processing of the data write request has failed, and thus even if the control unit 12 accesses the communication adapter 11 to acquire new state information during such processing, little impact is exerted on performance of the storage device 10, i.e., on actual operations.

In this way, according to the above mechanism, the control unit 12 can detect a decrease in light quantity of the light emitting element of the light emitting part at an early stage (before performance of the storage system 1 deteriorates significantly) without regularly monitoring the optical module 111 by polling etc. The user can know at an early stage the decrease in light quantity of the light emitting element based on the information output by the storage device 10 to the management device 8, and thus can quickly take a measure, such switching to an alternative optical module 111 for as processing that is being performed by the relevant optical module 111, or replacing the optical module 111.

The control unit 12 of the storage device 10 can newly acquire state information from the communication adapter 11 while suppressing impact on the performance of the storage system 1. The control unit 12 of the storage device 10 can monitor the light quantity of the light emitting element of the light emitting part by itself without relying on the information provided from the counter devices such as the host device 2 or the optical NW switch 5.

The above mechanism can be easily effectuated with only minor modifications to the existing software, which is implemented in the storage device 10, to effectuate processing when a data write request is received. For example, when the processes S411 through S415, S421, and S436 shown in FIG. 4 are assumed as existing processes, the above mechanism can be easily effectuated by simply adding the processes S431 through S435 to the program that effectuates the existing processes. The above mechanism can be effectuated without changing the basic configuration of the communication adapter 11.

### Second Embodiment

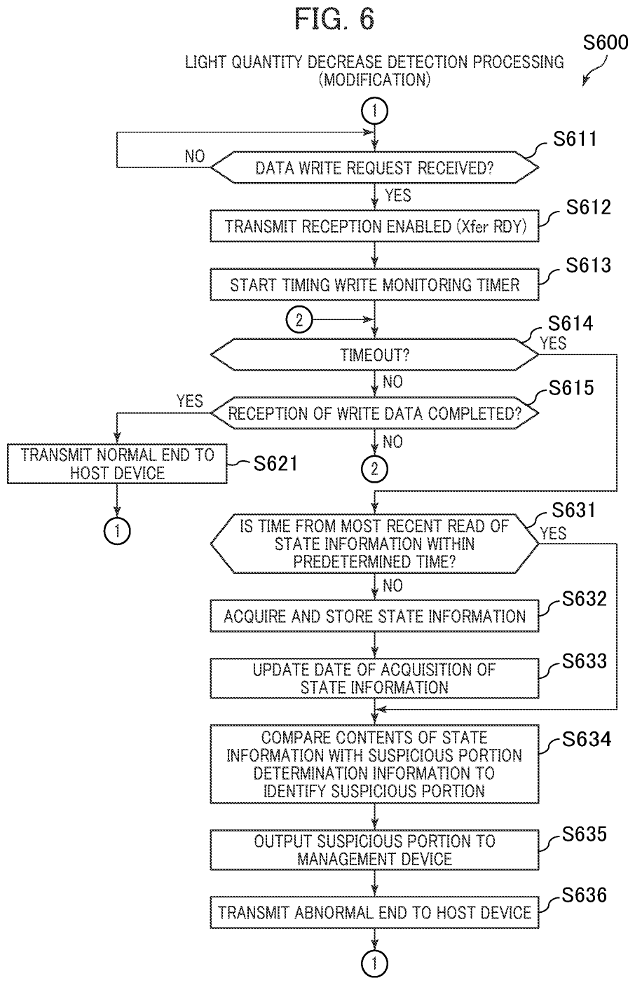

FIG. 6 is a flowchart illustrating the process (hereinafter, referred to as “suspicious portion determination process S600”) performed by the storage device 10 in the storage system 1 of a second embodiment of the invention. The flow of the suspicious portion determination processing S600 is basically similar to that of the light quantity decrease detection processing S400 shown in FIG. 4, but is partially different from that. In this processing, a portion where abnormality occurs (hereinafter referred to as “suspicious portion”) is identified. The suspicious portion determination processing S600 is now described with reference to FIG. 6. The configuration of the storage system 1 of the second embodiment is basically the same as the first embodiment.

The processes S611 to S615, S621, S631 to S633, and S636 in FIG. 6 are the same as the processes S411 to S415, S421, S431 to S433, and S436, respectively, in the light quantity decrease detection processing S400 shown in FIG. 4.

In S634, the control unit 12 compares the state information acquired from the communication adapter 11 (optical module 111) with the suspicious portion determination information stored in advance, and thus identifies a suspicious portion in components (software elements or hardware elements) of the storage system 1.

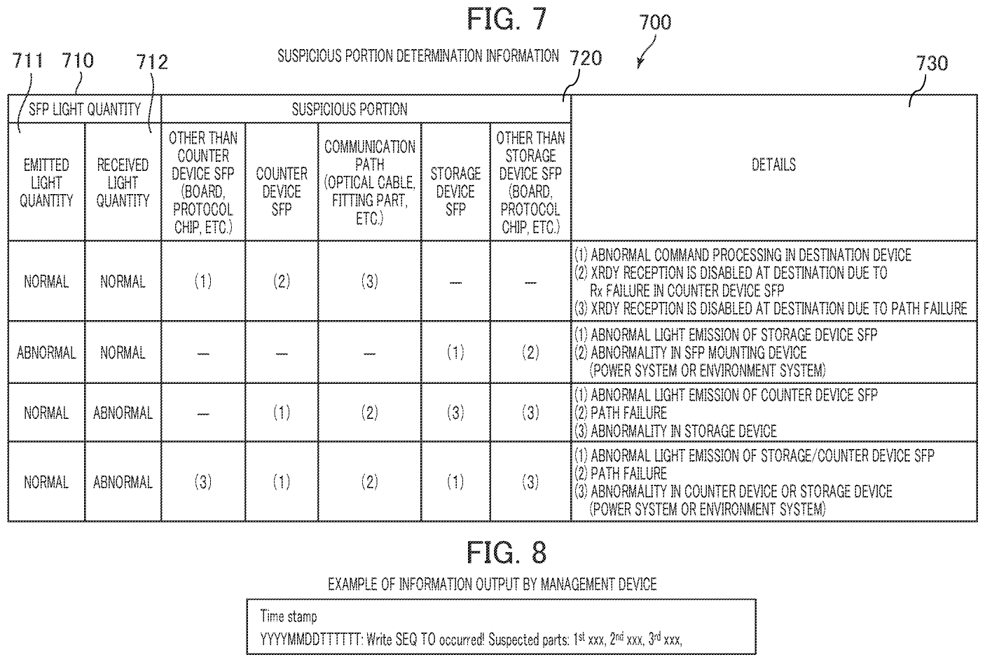

FIG. 7 illustrates an example of suspicious portion determination information. As illustrated in FIG. 7, the exemplified suspicious portion determination information 700 includes information indicating correspondence with one or more suspicious portion candidates 720 for each of combinations 710 of normality/abnormality 711 of the emitted light quantity of the light emitting element of the light emitting part of the optical module 111 and normality/abnormality 712 of the received light quantity of the light receiving element of the light receiving part of the optical module 111. Each bracketed value set in the suspicious portion candidates 720 in FIG. 7 indicates how likely it is that each of the suspicious portions corresponds to a corresponding combination 710 (the smaller the value is, the more likely it is that the relevant portion is the relevant suspicious portion). Furthermore, the normality/abnormality of the emitted light quantity of the light emitting element of the light emitting part of the optical module 111 is determined, for example, based on whether the aforementioned attenuation is above the aforementioned attenuation threshold (if the attenuation is equal to or larger than the attenuation threshold, the light quantity is determined normal, if the attenuation is less than the attenuation threshold, it is determined abnormal). The normality/abnormality of the received light quantity of the light receiving element of the light receiving part of the optical module 111 is determined, for example, based on whether the received light quantity is equal to or larger than a preset threshold (hereinafter referred to as “received light quantity threshold”) (if the received light quantity is equal to or larger than the received light quantity threshold, the received light quantity is determined normal, and if less than the threshold, determined abnormal).

Returning to FIG. 6, in S635, the control unit 12 transmits information indicating the identified suspicious portion to the management device 8. When receiving the information, the management device 8 outputs information based on the received information.

FIG. 8 is an example of the above information output by the management device 8 in S635 of FIG. 6. In this example, the management device 8 outputs information, indicating occurrence date of timeout and a candidate for the suspicious portion, as the above information.

Thus, in the storage system 1 of the second embodiment, the storage device 10 identifies the suspicious portion based on a combination of normality/abnormality (presence or absence of abnormality) of the emitted light quantity of the light emitting element and normality/abnormality (presence or absence of abnormality) of the received light quantity of the light receiving element, and outputs information indicating the identified suspicious portion. The user therefore can easily identify the portion of the abnormality by referring to the above information, and can take a necessary measure for the storage system 1 quickly and efficiently.

### Third Embodiment

In the storage system 1 of the first or second embodiment, the storage device 10 has acquired the state information from the optical module 111 with a trigger of timeout of the write monitoring timer. In a third embodiment set forth below, the storage device 10 acquires the state information from the optical module 111 with a trigger of detecting a correctable error in data transmitted/received to/from the host device 2. For example, a collectible error may be caused by a propagation signal error that occurs during establishing a communication link with a counter device.

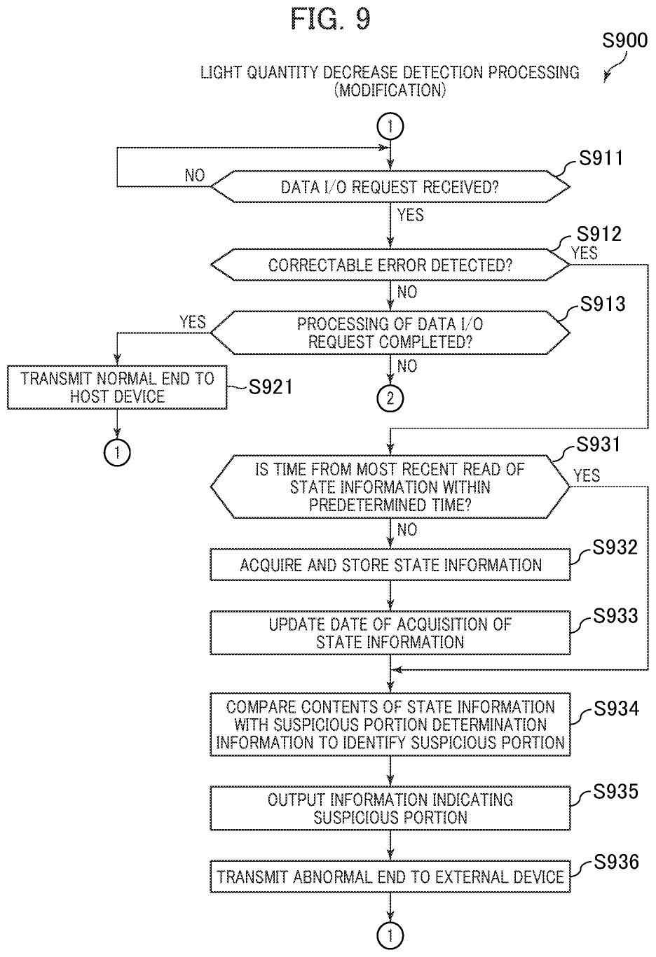

FIG. 9 is a flowchart illustrating processing (hereinafter referred to as “suspicious portion determination processing S900”) performed by the control unit 12 of the storage device 10 of the third embodiment. The suspicious portion determination processing S900 is now described with reference to FIG. 9. The configuration of the storage system 1 of the third embodiment is basically the same as the first embodiment.

The processes of S921 and S931 to S936 in FIG. 9 are the same as those of S621 and S631 to S636, respectively, in FIG. 6.

In S911, the control unit 12 monitors in real time reception of a data I/O request (data write request, data read request) from the host device 2 (S911: NO). When receiving the data I/O request from the host device 2 (S911: YES), the control unit 12 performs the processes from S912.

Subsequently, the control unit 12 monitors whether a correctable error has been detected and whether processing of the data I/O request has been completed (S912 to S913). If the processing of the data I/O request is completed without detecting a correctable error (S913: YES), the processing proceeds to S921. On the other hand, if a correctable error is detected before the processing of the data I/O request is completed (S912: YES), the processing advances to S931.

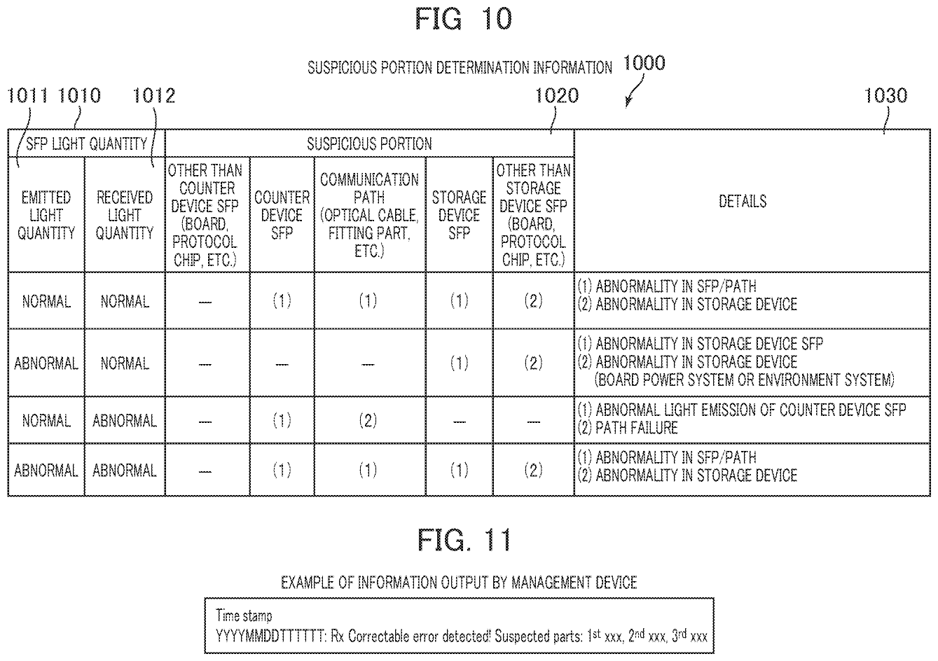

FIG. 10 shows an example of the suspicious portion determination information to be compared with the state information by the control unit 12 in S934. The illustrated suspicious portion determination information 1000 includes information indicating correspondence with one or more suspicious portion candidates 1020 for each of combinations 1010 of normality/abnormality 1011 of the emitted light quantity of the light emitting element of the light emitting part of the optical module 111 and normality/abnormality 1012 of the received light quantity of the light receiving element of the light receiving part of the optical module 111. Each of numerical values set in the suspicious portion candidates 1020 indicates how likely it is that each of the suspicious portions corresponds to the corresponding combination 1010 (the smaller the numerical value is, the more likely it is that the relevant portion is the relevant suspicious portion).

FIG. 11 is an example of information output by the management device 8 in S935 of FIG. 9. In this example, the management device 8 outputs information, indicating occurrence date of timeout and a candidate for the suspicious portion, as the above information.

As mentioned above, in the third embodiment, the storage device 10 acquires the state information from the communication adapter (optical module 111) with a trigger of detecting a correctable error, and outputs information on the light quantity and information indicating an identified suspicious portion to the management device 8. A user therefore can easily identify an abnormal portion with reference to the above information. This allows the user to take a necessary measure quickly and efficiently. The mechanism of the third embodiment can also be implemented together with the first embodiment or the second embodiment.

Although some embodiments of the invention have been described hereinbefore, the invention should not be limited to the embodiments, and may include various modifications while being not necessarily limited to those having all the described configurations.

For example, the invention can be applied to a different type of a storage system from the storage system 1 shown in FIG. 1, as long as the storage device includes the optical module. An example of a different type of the storage system includes one using a storage device (for example, an enterprise-type storage device) having a configuration, in which a multiple-channel adapter acting as a communication adapter and multiple drive adapters acting as a drive control unit are provided and connected together by switches such as high-speed crossbar switches.

What is claimed is:

1. A storage device that includes an optical module performing optical communication, the storage device receiving a data I/O request transmitted from another device via the optical module, and performing I/O processing responding to the data I/O request to a storage unit being communicably connected,
the optical module including a light emitting element that generates signal light to be transmitted to the another device, and a light receiving element that receives the signal light transmitted from the another device,
wherein the storage device performs:
upon receiving a data write request as the data I/O request from the another device, transmitting a reception enabled notification being information indicating a state where reception of write data for the data write request is enabled, and starting timing of a write monitoring timer being a timer that monitors timeout of the write data;
upon timeout of the write monitoring timer, acquiring emitted light quantity of the light emitting element; and
outputting information indicating the acquired emitted light quantity.

2. The storage device according to claim 1,
wherein the storage device determines whether the light emitting element is abnormal based on the emitted light quantity of the light emitting element,
determines whether the light receiving element is abnormal based on the received light quantity of the light receiving element,
stores suspicious portion determination information being information indicating a suspicious portion corresponding to a combination of a determination result on whether the light emitting element is abnormal and a determination result on whether the light receiving element is abnormal,
newly acquires emitted light quantity of the light emitting element and received light quantity of the light receiving element,
compares a combination of a determination result on whether the light emitting element is abnormal based on the newly acquired emitted light quantity and a determination result on whether the light receiving element is abnormal based on the newly acquired received light quantity with the suspicious portion determination information, and thus identifies the suspicious portion, and
outputs information indicating the identified suspicious portion.

3. The storage device according to claim 2,
wherein the storage device monitors whether a correctable error exists in the optical communication,
newly acquires the emitted light quantity of the light emitting element and the received light quantity of the light receiving element with a trigger of detecting the correctable error,
compares a combination of a determination result on whether the light emitting element is abnormal based on the newly acquired emitted light quantity and a determination result on whether the light receiving element is abnormal based on the newly acquired received light quantity with the suspicious portion determination information, thereby identifies the suspicious portion, and
outputs information indicating the identified suspicious portion.

4. The storage device according to claim 2,
wherein the optical module stores state information being information including emitted light quantity measured for the light emitting element, and received light quantity measured for the light receiving element, and
the storage device acquires the state information from the optical module, thereby acquires the emitted light quantity of the light emitting element and the received light quantity of the light receiving element.

5. The storage device according to claim 4,
wherein the state information includes an initial value of the emitted light quantity of the light emitting element, and
the storage device determines that when attenuation of the emitted light quantity determined from a difference between the initial value of the emitted light quantity and the newly acquired emitted light quantity is equal to or larger than a preset threshold, the light emitting element is abnormal, and
when the newly acquired received light quantity is less than the preset threshold, the received light quantity is abnormal.

6. The storage device according to claim 4, comprising:
a control unit that performs I/O processing responding to the data I/O request, timing of the write monitoring timer, and processing of, upon timeout of the write monitoring timer, acquiring the emitted light quantity of the light emitting element and outputting information indicating the emitted light quantity; and
a communication adapter including the optical module, and a processor that communicates with the control unit and mutually converts communication protocols for the optical communication and for communication performed with the control unit,
wherein the control unit acquires the state information stored in the optical module via the processor of the communication adapter.

7. The storage device according to claim 6,
wherein the control unit acquires the new state information if the current time exceeds a predetermined time since the most recent acquisition of the state information.

8. A method for controlling a storage device,
the storage device including an optical module performing optical communication, and
receiving a data I/O request transmitted from another device via the optical module, and performing I/O processing responding to the data I/O request to a storage unit being communicably connected,
the optical module including a light emitting element that generates signal light to be transmitted to the another device and a light receiving element that receives the signal light transmitted from the another device,
wherein the storage device performs the steps of:
upon receiving a data write request as the data I/O request from the another device, transmitting a reception enabled notification being information indicating a state where reception of write data for the data write request is enabled to the another device, and starting timing of a write monitoring timer being a timer that monitors timeout of the write data;
upon timeout of the write monitoring timer, acquiring emitted light quantity of the light emitting element; and
outputting information indicating the acquired emitted light quantity.

9. The method according to claim 8,
wherein the storage device further performs the steps of:
determining whether the light emitting element is abnormal based on the emitted light quantity of the light emitting element;
determining whether the light receiving element is abnormal based on the received light quantity of the light receiving element;
storing suspicious portion determination information being information indicating a suspicious portion corresponding to a combination of a determination result on whether the light emitting element is abnormal and a determination result on whether the light receiving element is abnormal;
newly acquiring emitted light quantity of the light emitting element and received light quantity of the light receiving element;
comparing a combination of a determination result on whether the light emitting element is abnormal based on the newly acquired emitted light quantity and a determination result on whether the light receiving element is abnormal based on the newly acquired received light quantity with the suspicious portion determination information, thereby identifying the suspicious portion; and
outputting information indicating the identified suspicious portion.

10. The method according to claim 9,
wherein the storage device further performs the steps of:
monitoring whether a correctable error exists in the optical communication;
newly acquiring the emitted light quantity of the light emitting element and the received light quantity of the light receiving element with a trigger of detecting the correctable error;
comparing a combination of a determination result on whether the light emitting element is abnormal based on the newly acquired emitted light quantity and a determination result on whether the light receiving element is abnormal based on the newly acquired received light quantity with the suspicious portion determination information, thereby identifying the suspicious portion; and
outputting information indicating the identified suspicious portion.

11. The storage device according to claim 3,
wherein the optical module stores state information being information including emitted light quantity measured for the light emitting element, and received light quantity measured for the light receiving element, and
the storage device acquires the state information from the optical module, thereby acquires the emitted light quantity of the light emitting element and the received light quantity of the light receiving element.
